(19) United States
(12) Patent Application Publication
(10) Pub. No.: US 2017/0091854 A1
(43) Pub. Date: Mar. 30, 2017

(54) METHOD OF INTERACTIVE SHOPPING OVER INTERNET

(71) Applicants: Ray Wang, McLean, VA (US); Chih Wang, McLean, VA (US)

(72) Inventors: Ray Wang, McLean, VA (US); Chih Wang, McLean, VA (US)

(21) Appl. No.: 14/864,946

(22) Filed: Sep. 25, 2015

(51) Int. Cl. G06Q 30/06; G06Q 30/02

(52) U.S. Cl. CPC G06Q 30/0643; G06Q 30/0277

(57) ABSTRACT

Method for interactive shopping over Internet provides online shoppers multidimensional interactions with the e-retail's merchandise, as well as with other online shoppers and online store clerks, as if the shoppers were at a real store.

### FIELD OF THE INVENTION

The present invention relates to World Wide Web (WWW) based e-retail or e-commerce and, more particularly, to a method and system for Internet shopping.

### BACKGROUND OF THE INVENTION

U.S. e-retail sales are expected to grow from $263 billion in 2013 to $414 billion in 2018, a compound annual growth rate of 9.5%, according to a new online retail sales forecast from Forrester Research Inc. E-retail's share of total retail sales will continue to inch upward, from 8% in 2013 to 11% in 2018. The dollar growth from the actual 2013 figure of $263 billion to the forecast $414 billion for 2018 is 57.4%.

Global e-commerce sales will reach $1.316 trillion this year, up 22.2% from $1.077 trillion in 2013, and web sales will account for 5.9% of all global retail sales in 2014. In 2015, worldwide web sales will increase nearly 21.0% to $1.592 trillion. Global e-commerce will increase 18.6% in 2016 to $1.888 trillion, with web sales accounting for 7.4% of total retail.

There are numerous internet-based online e-retail stores operating globally. For example, just to name a few, Amazon.com, Inc. is an American e-commerce company with revenue US$88.988 billion in 2014. Alibaba Group Holding Limited is a Chinese e-commerce company that provides consumer-to-consumer, business-to-consumer and business-to-business sales services via web portals with revenue US$12.27 billion in 2015. Argos is a British catalogue retailer operating in the United Kingdom and Ireland and is one of the largest high street retailers online in the United Kingdom with revenue US$4.7 billion annually.

The National Retail Federation said one third of goods are expected to be returned due to disappointed purchases which accounted for a return rate of between 20% and 40% for Internet sales. In addition, 72% of retailers cover the cost of delivery and/or return of items, a service which can prove expensive.

The biggest problem with e-retail is lacking of true shopping atmosphere that shoppers would experience at a real store.

Another problem to e-retail is the discrepancy between the product description (both in text and image) and online shopper's anticipation. Retailers can and do provide detailed measurements, and sometimes even tell the online shoppers the size and height of the model so they get an idea of proportion. But with sizing and coloring varying wildly between different brands, ultimately it's all a bit of a gamble.

There have been solutions utilizing a customized virtual show room technology to guide online shoppers throughout the purchase process. For example, Fitiquette, a San-Francisco based company, utilizes virtual fitting room model which works by guiding the online shoppers through the creation of a customized virtual mannequin that exactly resembles shopper's own measurements. They can then suggest clothes that would fit, showing you a 360 view of how the garment would move and drape in real life.

Fits.me is another company with a similar model, which provides a virtual try out over up to 2,000 different models on their website.

Zugara, another company but with different approach, created a “Webcam Social Shopper” to let consumers ‘hold’ different items of clothing up against themselves, using augmented reality technology.

One problem associated with the online virtual model is that it offers limited human interaction through a set of questionnaire for shopper's input which is mainly suitable for shopping clothes and shoes.

The other problem is that the virtual model often requires some computer know-how and it may appeal to a tech fan base but don't translate all that well to the majority online shopping population.

Another problem with nowadays online shopping is its lacking of multi-dimensional interactions between Internet online shopper-to-shopper and online shopper-to-store.

Thus, it is desirable to solve some of the problems associated Internet online shopping with a spontaneous interactive mechanism between online shopper-to-store and online shopper-to-shopper as if they were at the same physical location.

It would be advantageous to provide an integrated shopping platform on which the online shoppers can, but are not limited to, browse the merchandise in 2 or 3-dimension display, receive instant online advertising and/or promotion, exchange shopping tips between online shoppers, invite friends to join online shopping at a virtual store, post inquiry and receive response from online stores, post shopping review, negotiate price online, place bid online, pay and arrange shipment online, arrange exchange/return online, or playing video games online.

It would also be advantageous to further provide online shoppers' social interaction with other online shoppers via promotional events to raise shoppers' market awareness.

It would further be advantageous to provide an emulated store layout in 2 or 3-dimension display where merchandises were placed and sold as if they were at real stores.

### SUMMARY OF THE INVENTION

In accordance with the present invention, there is provided method for Internet interactive shopping where online shoppers can interact with different e-retail's merchandise, as well as other online shoppers and online store clerks, as if the shoppers were at a real shop.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a top view of a representation of online shopping stores layout illustrating an exemplary virtual online shopping site; and

FIG. 2 is an example of a display of virtual shopping stores that the online shopper viewed from a computer monitor or a display device.

FIG. 3 is an example of a display of virtual shopping store that the online shopper viewed from a computer monitor or a display device.

FIG. 4 is a flow diagram of to show that one online shopper invites one or more friends to join online shopping

FIG. 5 is a flow diagram of a shopper negotiating price with online sales representative

FIG. 6 is an example of applying virtual shopping site to a virtual museum

For purposes of clarity and brevity, like elements and components will bear the same designations and numbering throughout the Figures.

### DESCRIPTION OF THE PREFERRED EMBODIMENT

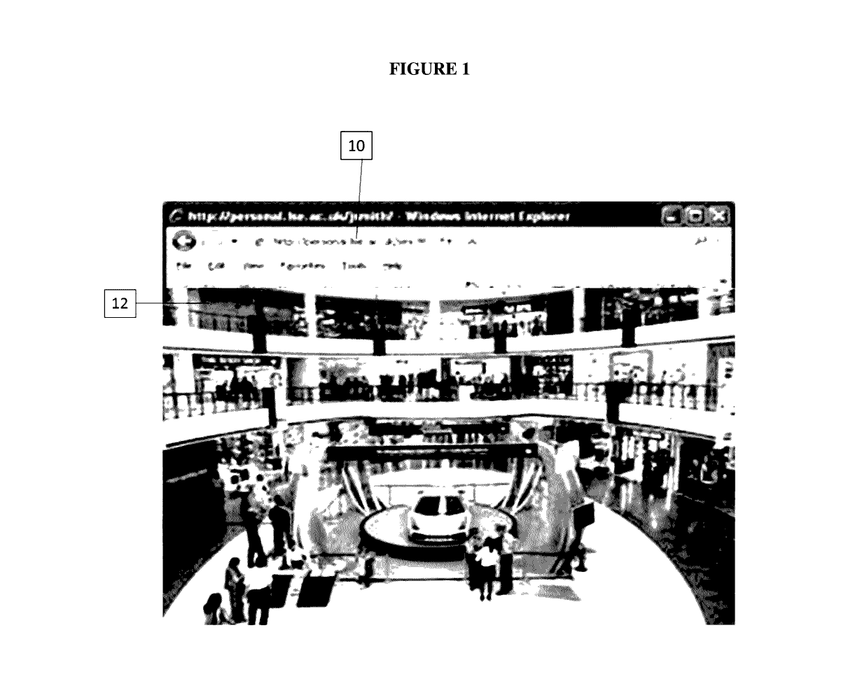

FIG. 1 is a top view of a virtual online shopping site 10 viewed through a universal resource locator (URL) with one or more virtual online shops 12 that is displayed in 2 or 3-dimension which is created in software programming and web-based markup languages and protocol stack.

A virtual online shopping site 10 includes one or many online shops or stores 12. An online shopping site is created via computer software design utilizing software programming, web-based markup languages, and protocol stack. Thus, a virtual online shopping site is a user interface between online shoppers and e-retails.

Online shoppers browse and shop merchandise and/or services via a web page which is linked by universal resource locator (URL). URL is a reference to a resource that specifies the location of the resource on a computer network and a mechanism for retrieving it. URLs occur most commonly to reference web pages (http), but are also used for file transfer (ftp), email (mailto), database access (JDBC), and many other applications.

Most web browsers display the URL of a web page above the page in an address bar. A typical URL has the form http://www.example.com/index.html, which indicates the protocol type (http), the domain name, (www.example.com), and the specific web page (index.html).

Software programming is any computer program language such as, but is not limited to, C/C++, Java, and low-level assembly.

Web-based markup languages are designed for the processing, definition and presentation of text. The language specifies code for formatting, both the web page layout and style, within a text file. The code used to specify the formatting are called tags. HTML, XHTML, XML, or SGML is an example of a widely known and used markup language.

Protocol stack is an implementation of a computer networking protocol suite. The suite is the definition of the protocols, and the stack is the software implementation of them. In practical implementation, protocol stacks are often divided into three major sections: media, transport, and applications. A particular operating system or platform will often have two well-defined software interfaces: one between the media and transport layers, and one between the transport layers and applications. The media-to-transport interface defines how transport protocol software makes use of particular media and hardware types. For example, this interface level would define how TCP/IP transport software would talk to Ethernet hardware. Examples of these interfaces include ODI and NDIS in the Microsoft Windows and DOS environment.

The application-to-transport interface defines how application programs make use of the transport layers. For example, this interface level would define how a web browser program would talk to TCP/IP transport software. Examples of these interfaces include Berkeley sockets and System V STREAMS in the Unix world, and Winsock in the Microsoft world.

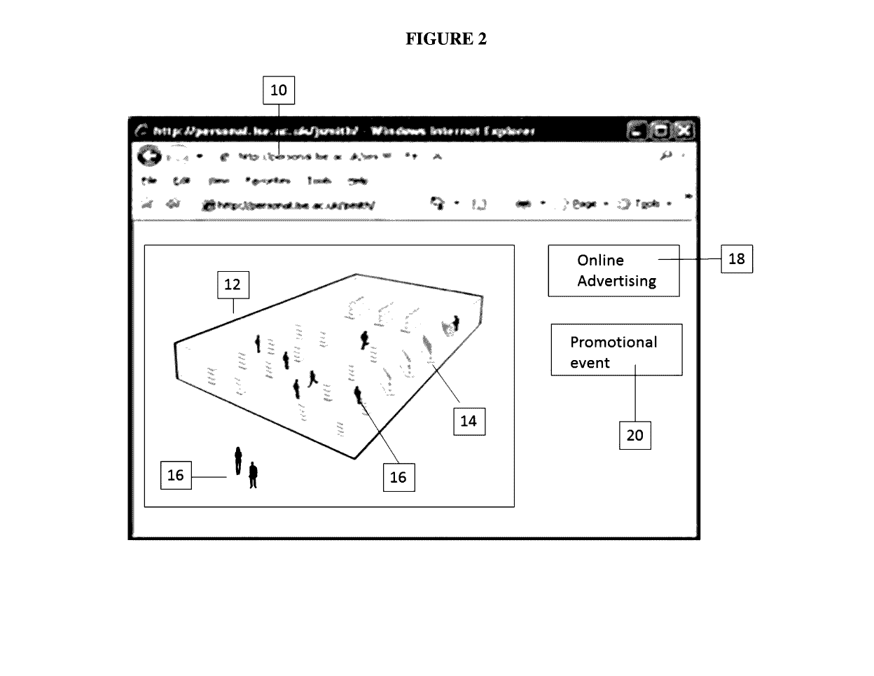

FIG. 2 is an example of a display of virtual shopping stores that the online shopper viewed from a computer monitor or a display device. The online shop 12 includes one or more virtual shelf 14 each with unique shelf identification serves as an index to merchandise catalog. Each virtual shelf 14 may include one or more virtual bins, virtual boxes, or virtual dividers to hold displayed merchandises. Each virtual shelf 14 and its subsequent dividers can be zoom in or out for a desire view.

The displayed merchandise is a 2- or 3-dimensional object which is shown in graphical representation as, but is not limited to, a picture, video, voice, or text. Online shopper can browse a detail of information on any displayed merchandise via a computer input device such as, but is not limited to, a keyboard, computer mouse, or a pointer. The detail information of a merchandise includes but are not limited to: product description, promotional offers such as discount, promotional events such as awarding prizes, shopping games, price, outstanding quantity, similar merchandise, etc., While browsing the merchandise the online shopper can interact with other online shoppers or with online store clerk via online voice/video chat, or message sharing engine includes, but is not limited to, short message service, Yahoo messenger, Google messenger, Google hangouts.

One or more virtual person 16 may be shown on the online virtual shop. The virtual person can be, but is not limited to, one or more of the following: online shopper, online store clerk, online store sales representative, online shopping helpdesk.

The virtual person 16 can be represented and displayed as the following, but is not limited to: a symbol, a virtual image, a picture image, a name, a screen name, or any representation that uniquely can identify the virtual person. The virtual person, from Internet access device such as a computer, a laptop computer, a smart phone, or a tablet, can see the location of her or his representation, as well as other online shoppers, online store clerks, or online shopping site helpdesk.

The online virtual person 16 each has unique identification to distinguish them between, but is not limited to: online shoppers, online store clerk, online shopping site helpdesk, or other online users.

The online virtual person 16 can initiate conversation in text, voice, or video call with other online shoppers, online store clerks, online shopping site helpdesk, or other online users.

The web page of a virtual online shopping site 10 has displays for, but is not limited to, online advertising 18 or public announcement for promotional event 20.

Online advertising 18 also called online marketing or Internet advertising is a form of marketing and advertising which uses the Internet to deliver promotional marketing messages to consumers. It includes email marketing, search engine marketing (SEM), social media marketing, many types of display advertising 18 (including web banner advertising), and mobile advertising. Like other advertising media, online advertising 18 frequently involves both a publisher, who integrates advertisements into its online content, and an advertiser, who provides the advertisements to be displayed on the publisher's content. Other potential participants include advertising agencies that help generate and place the ad copy, an ad server which technologically delivers the ad and tracks statistics, and advertising affiliates who do independent promotional work for the advertiser.

The promotional event 20 refers to any activity that is raising customer awareness of a product or brand, generating sales and creating brand loyalty.

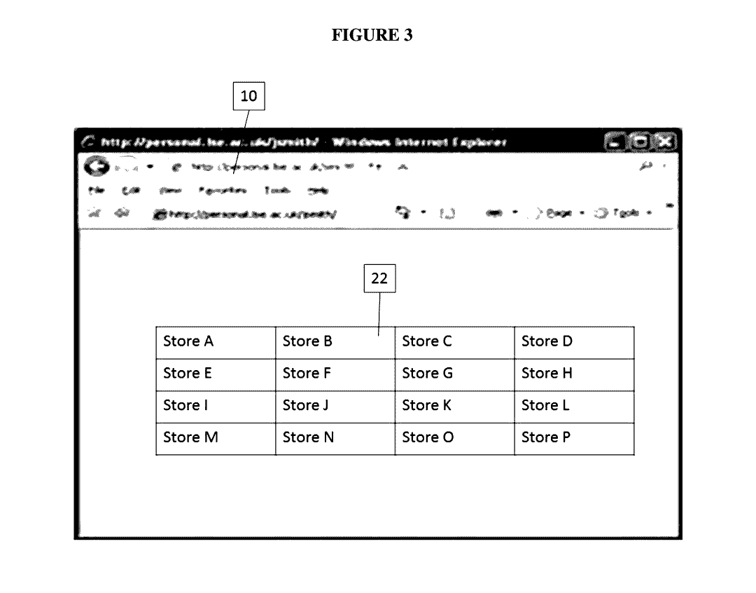

FIG. 3 is an example of a display of a list of participated virtual shopping stores 22 at one online shopping site 10. A list of participated online stores 22 provides online shoppers an index to listed stores. The representation of the list of participated online stores 22 can be displayed in any format such as, but is not limited to, a store catalog, a store map, an alphabetic ordered list. The online shopper can access and enter each listed store through a point and click device such as a computer mouse.

The construction of a virtual online shopping site 10 is done by computer software; the representation of an online store is determined by software creation which includes any forms, shapes, and styles.

The invention of the virtual shopping site 10 is also applicable to other applications such as but is not limited to, a virtual museum, virtual flea market, virtual strip mall, virtual school, virtual classroom, or virtual tourism.

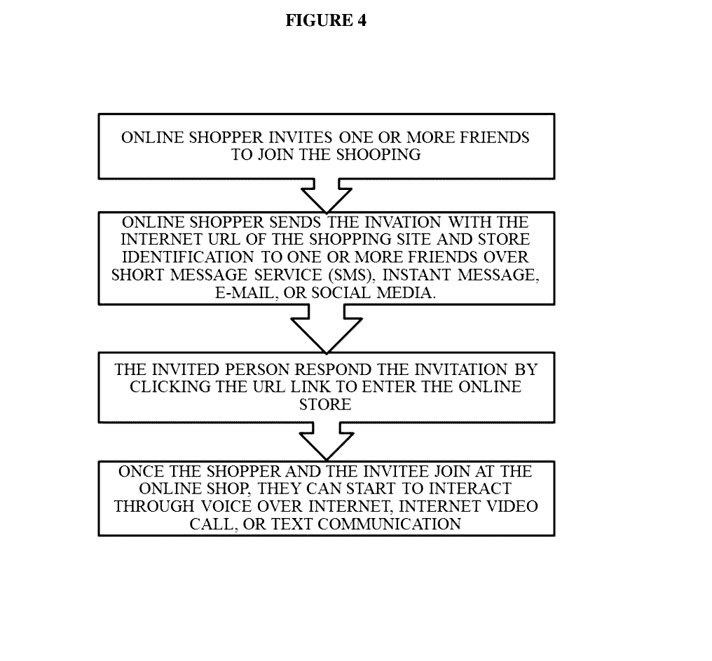

FIG. 4 is a flow diagram to show that one online shopper invites one or more friends to join the online shopping. Shopper and one or more friends may be physically located at different places. Once the friends responded to the invitation they can join the shopper at the online store via Internet.

Shopper and friends located physically at different places use Internet browser to view the same online store. Friends are given online store's URL link through an invitation message sent by the shopper.

The shopper and each of the friends have unique identifications, such as names or unique identification, for them to recognize each other at the online store. Shopper and friends can identify and see each other from their own Internet browser.

Once the shopper and friends are connected at the online store over the Internet they can start interactions via, but is not limited to, text messaging, voice over Internet, video call over Internet, or instant messaging.

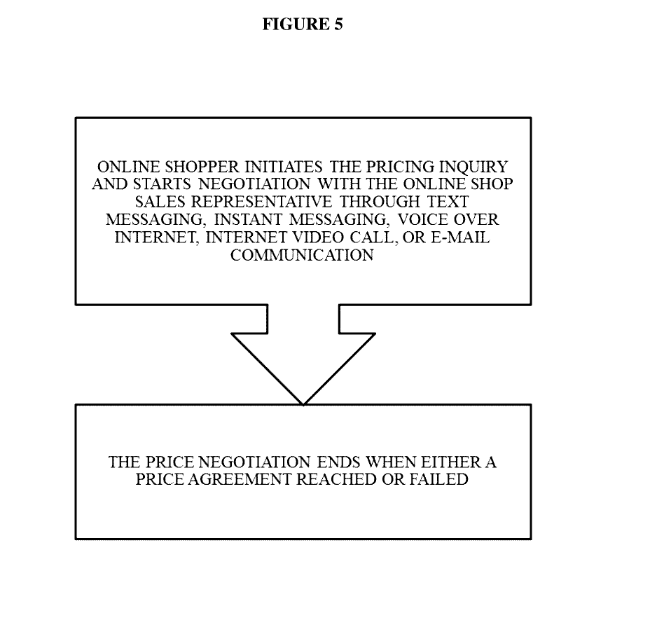

FIG. 5 is a flow diagram of a shopper negotiating price with online sales representative. A shopper can initiate a price negotiation with the online sales representative through a software function build inside the web browser. The software function may be implemented, but is not limited to, Java, C/C++, or a low-level programming language.

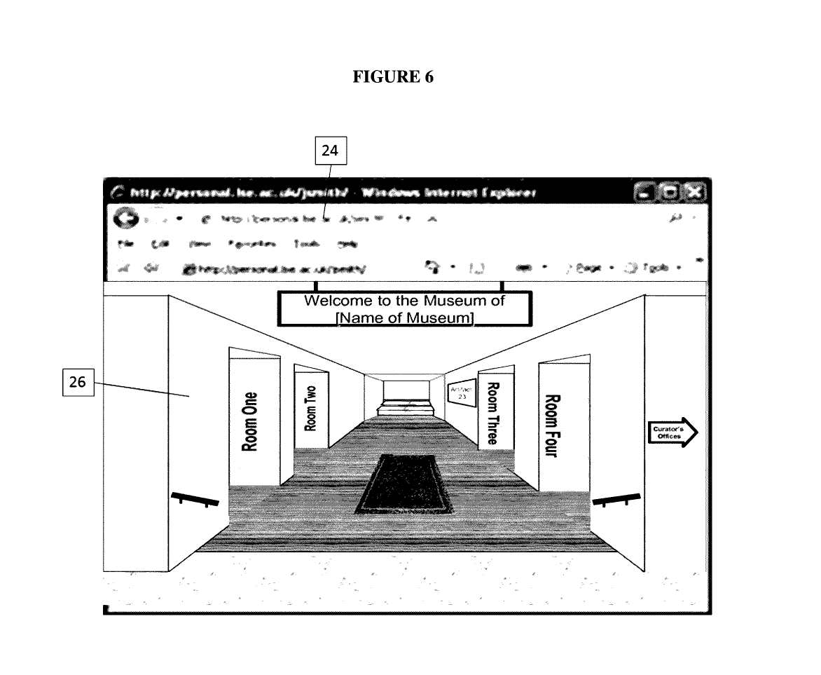

FIG. 6 is an example of applying the virtual shopping site 10 to virtual museum 24 where people meet online for a tour. The virtual museum 24 includes one or many rooms or exhibits areas 26 for art display. In this application, the proposed method allows people to view the exhibition and share communications over an Internet web browser.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method of interactive shopping over Internet, comprising:
a layout, for representing a 2 or 3-dimension display of an online store layout where merchandises are placed and sold online;
a virtual shelf, for showing the location of the merchandises;
a virtual person, for displaying the location of the online shoppers and emulated store clerks;
a display, for viewing a 2 or 3-dimension object or merchandise, displaying online advertisement, and running online shopping promotional event;
an online advertising, for displaying online advertisement, simultaneously connected to said display and online shoppers; and
a promotional event, for running online promotion events to raise customer awareness of a product or brand, generating sales, and creating brand loyalty, simultaneously connected to said display and online shoppers.

2. The method for interactive shopping over Internet in accordance with claim 1, wherein said means for providing an online shopping platform on which includes one or many online stores.

3. The method for interactive shopping over Internet in accordance with claim 1, wherein said means for providing an online shopping platform offering Internet-based interactions between online shoppers and between online shopper and online store sales representative.

4. The method for interactive shopping over Internet in accordance with claim 1, wherein said means for online shoppers to invite geographically dispersed friends to join the shopping site over Internet.
